(19) United States
(12) Patent Application Publication
(10) Pub. No.: US 2004/0143200 A1
(43) Pub. Date: Jul. 22, 2004

(54) Tunning fork type therapeutic utensil

(76) Inventor: Hiroshi Nogami, Shizuoka-shi (JP)

Correspondence Address: JORDAN AND HAMBURG LLP, 122 EAST 42ND STREET, SUITE 4000, NEW YORK, NY, 10168, US

(21) Appl. No.: 10/475,417

(22) PCT Filed: Apr. 23, 2002
(86) PCT No.: PCT/JP02/04015

(30) Foreign Application Priority Data
Apr. 23, 2001 (JP) 2001-12461

(51) Int. Cl. A61H 23/00

(52) U.S. Cl. 601/46; 601/67; 601/68

(57) ABSTRACT

The U-shaped base of a U-shaped vibrating element 1 is provided with a transmission rod integrally attached thereto. Further, said transmission rod 2 is attached with a grip portion 3, which in turn is integrally attached with a press member 4 to be pressed against affected areas of patients. Thus constructed, it is possible to provide a tuning fork type therapeutic utensil inexpensive, easy to handle and providing remarkable curing effects not only for the surfaces of the body but also deep and extensively into the body as far as into the osseous tissues.

### FIELD OF THE INVENTION

The present invention relates to a tuning fork type therapeutic utensil which is used for lessening symptoms such as swollen lymph glands, stiff shoulders or the like.

### BACKGROUND OF THE INVENTION

Conventionally, healing art such as massaging or acupressure is done manually or by use of tools for lessening lymph glands, stiff shoulders or the like.

However, such conventional healing art imposes such a strain to massagers or acupressure therapists that repetitive and long time attendance on a number of patients is unbearable to them. Even if conventional tools are used for such purposes, there are problems that not only therapeutic effects can be insufficient but also such tools are in many cases too expensive. The conventional electric therapeutic tools, for example, could only offer therapeutic effects to portions near the patient's body surface.

The present invention has been made to solve the above problems and its object is to provide a tuning fork type therapeutic utensil which is inexpensive, handy and capable of showing remarkable therapeutic effects on a wide variety of symptoms for not only around the body surface but also deep into the osseous tissues.

### DISCLOSURE OF THE INVENTION

The tuning fork type therapeutic utensil according to the present invention is characterized by comprising a U-shaped vibrating element, a transmission rod extending from a base of said U-shaped vibrating element and a pressing member attached to a tip end of said transmission rod and further by including a grip provided said transmission rod.

### BRIEF DESCRIPTION OF THE DRAWINGS

FIG. 1 is an explanatory view of the tuning fork type therapeutic utensil of one embodiment of the invention;

FIG. 2 shows the tuning fork type therapeutic utensil of FIG. 1 being used;

FIG. 3 is an explanatory view of the tuning fork type therapeutic utensil according to another embodiment of the present invention;

FIG. 4 is an explanatory view of the tuning fork type therapeutic utensil according to a further embodiment of the present invention; FIG. 4 is an explanatory view of the tuning fork type therapeutic utensil according to a further embodiment of the present invention;

FIG. 5 is an explanatory view of the tuning fork type therapeutic utensil according to a still further embodiment of the present invention;

FIG. 6 is an explanatory view of a still further embodiment having a modified pad; and

FIG. 7 is an explanatory view of a vibrating element and a pad being connected by a transmission rod.

### BEST MODE FOR EMBODYING THE INVENTION

Hereinafter, embodiments of the present invention will be explained with reference to the drawings.

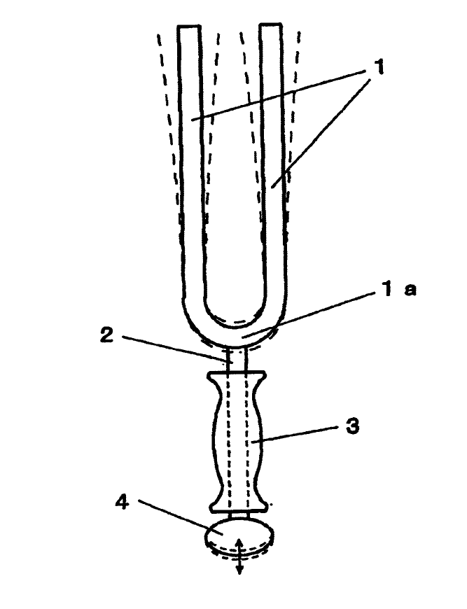

In FIG. 1, the numeral 1 denotes a U-shaped vibrating element made of for example ferrous metal materials such as steel, stainless steel or alloy materials; non-ferrous metal materials such as aluminum, brass, bronze or alloys thereof. When struck by a hammer, said U-shaped vibrating element are caused to vibrate at a certain frequency as shown in a broken line. The base 1a of the vibrating element 1 is curved in the form of the letter U.

Said U-shaped base 1a of said vibrating element has a transmission rod 2 integrally formed or attached. It is preferred that said transmission rod 2 is generally orientated in the direction of the normal line of said U-shaped base 1a (a line perpendicular to the tangent line thereof) in the interest of the transmission of vibration. Said transmission rod 2 is also made of a metal similar to the vibrating element 1.

A grip section 3 is attached to said transmission rod 2 therearound. Said grip section 3 may be made of any material so long as it provides an easy grip by one hand and in a form or material which minimizes the damping of the vibration of said transmission rod 2; for example rubber or wooden materials are preferably used.

Said transmission rod 2 has a press member 4 integrally formed or attached to a tip end thereof. Said press member 4 may be made of any materials so long as it has a function to transmit the vibration therefrom when pressed against the affected area directly or indirectly with a piece of cloth therebetween, for example, the material may be suitably selected from metal, plastic, rubber, wood or the like.

Thus constructed, the tuning fork type therapeutic utensil of the invention is caused to vibrate laterally as shown by the broken line in FIG. 1 at a predetermined frequency (preferably 50-200 Hz) when the U-shaped vibrating element 1 is hit by a hammer. When the vibrating element vibrates laterally, the U-shaped base portion 1a vibrates longitudinally in the direction perpendicular thereto. The amplitude of said longitudinal vibration of the U-shaped base portion 1a is limited as compared to that of the lateral vibration of the vibrating element 1 though the vibration impact thereof is strong enough to such an extent to make the pressing member 4 to vibrate in the arrow-marked directions forcefully and positively.

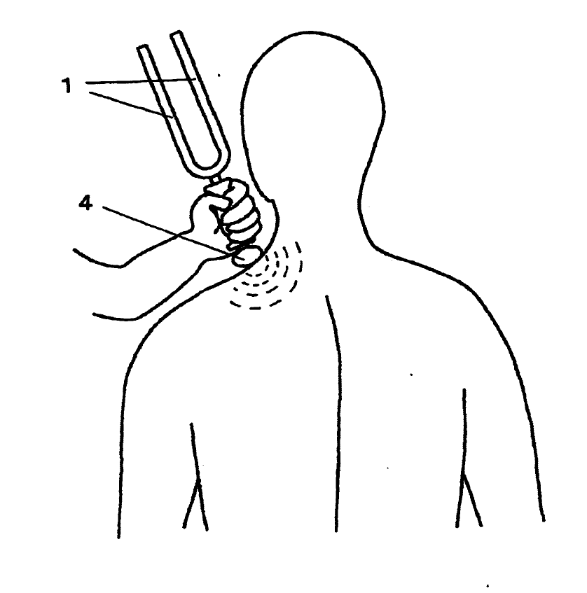

If the thus vibrating press member 4 is pressed against affected areas of the patient as shown in FIG. 2, the vibration works on the affected areas to show various curing effects such as removing stasis including retention or congestion, unstiffening mussels, or the like.

Examples of clinical effects by the tuning fork type therapeutic utensil of the invention may be listed as follows.

1) Lymph fluid clogging was solved by “strong wave emitted by the tuning fork” to make the patient's body slim by removing swells. Further, the lymph fluid was made normal such that the inherent function of the patient's immune system are restored against viruses, bacterial pathogens or the like.

2) Muscle pains were removed by pressing the tuning fork against the affected areas.

3) When the tuning fork was pressed against the aching repeatedly, the pain was relieved for the patient to walk keeping a good posture.

4) When the tuning fork was pressed against a patient's right ear with a severe hearing impairment for ten minutes, the patient had come to turn his right ear in response to another person's words.

5) When the tuning fork was pressed against an affected area between the scalp and the rear of an ear, the patient's headache was relieved.

6) When the tuning fork was pressed against an aching head for about ten minutes, the headache was relieved.

7) When the tuning fork was pressed against a seriously aching portion at the base of a thumb, the pain was relieved.

8) When the tuning fork was pressed against the coccygeal bone twice, the bowel movement of the patient was improved the next day.

9) When the tuning fork was pressed against the areas surrounding the eyes of a computer programmer suffering from impaired vision due to long time watch of the monitor, the eyesight was improved.

10) When the tuning fork was pressed against patients suffering from cataract or glaucoma, its improvement was observed.

11) When the tuning fork was pressed against deformed portions of the patient's face, the deformation was straightened.

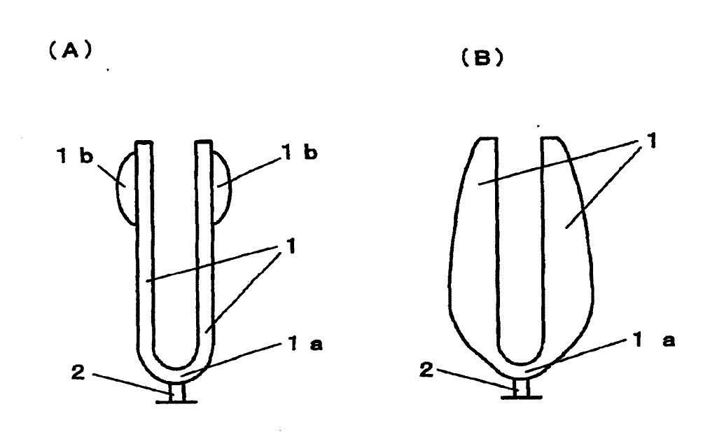

FIG. 3(A) and FIG. 3(B) show other embodiments of said U-shaped vibrating element; that is, poise members 1b are attached to the upper outside portions thereof as shown in FIG. 3(A) and a tuning fork having a bulky size was prepared as shown in FIG. 3(B).

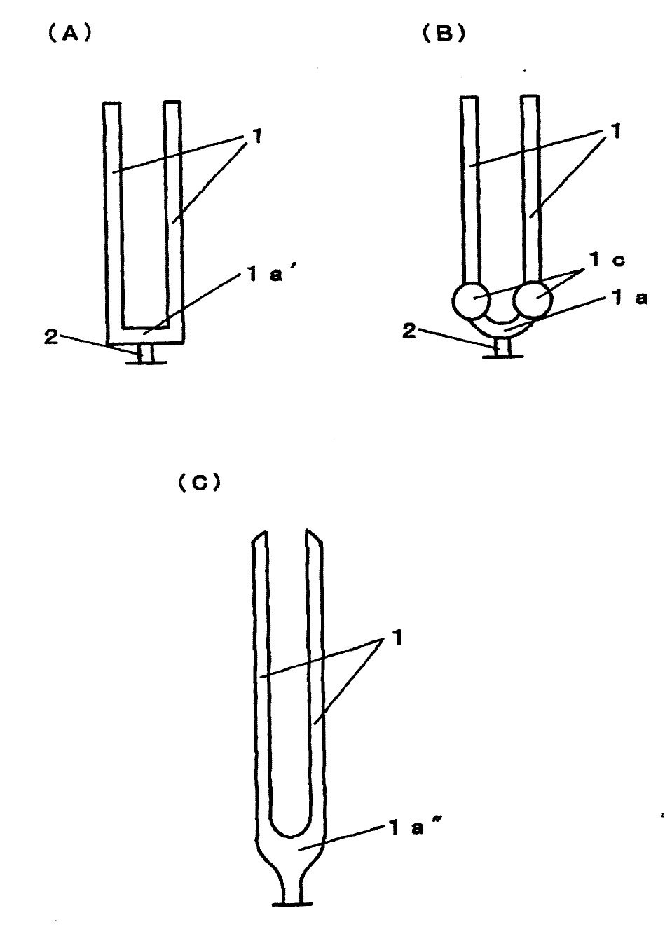

FIGS. 4(A) and 4(B) show further embodiments of said U-shaped vibrating element; that is, the base section 1a′ is formed with right-angled corners as shown in FIG. 4(A), large diameter stationary portions 1c are formed between the vibrating element 1 and the base portion 1a thereof as shown in FIG. 4(B), and the U-shaped base portion 1a″ are generally formed thicker as shown in FIG. 4(C) such that the vibration from the vibrating element 1 is received by the U-shaped base portion effectively.

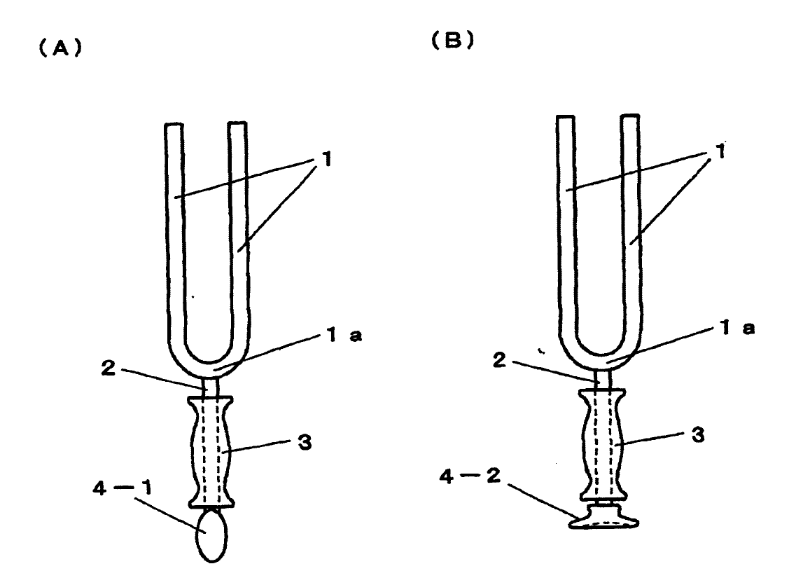

FIGS. 5(A) and 5(B) show still further embodiments of said U-shaped vibrating element; that is, the press portion 4-1 is provided in the form of a substantially elliptic member having a somewhat pointed tip to provide a locally concentrated curing effect as shown in FIG. 5(A), the press portion 4-1 is provided in the form of a substantially flat member as shown in FIG. 5(B) to provide effective variations in terms of size; that is, a small size one (having a diameter of about 10 mm) is for the face, a medium size one (having a diameter of about 25 mm) is for the head, and a large size one (having a diameter of about 30 mm) is for the upper or lower back and legs.

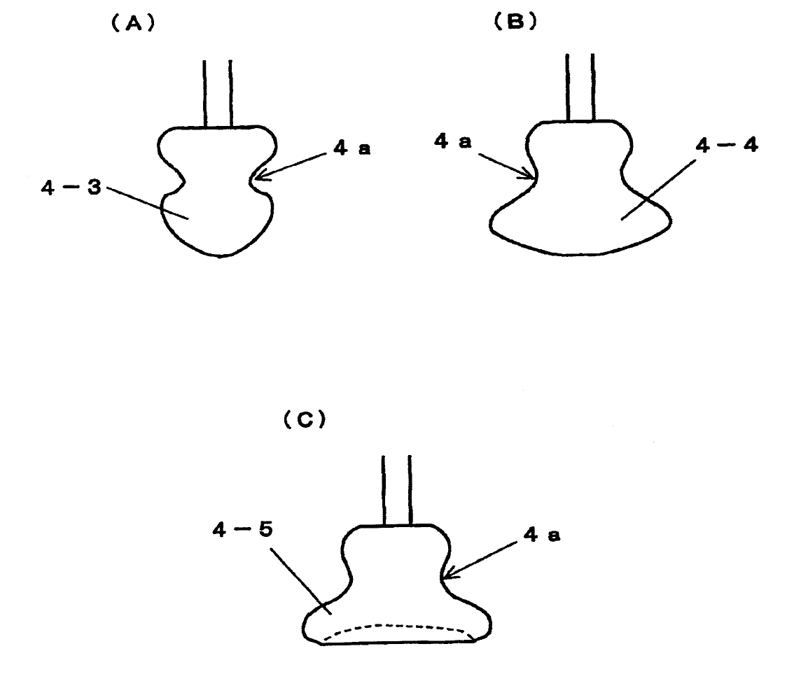

It is to be noted that said grip portion 3 may be omitted because the therapist can grip the transmission rod 2 directly. Otherwise, as shown in FIGS. 6(A), 6(B) and 6(C), said press member 4 is formed with an annular recess 4a at an intermediate portion thereof to provide a grip for fingers for helping press the press member 4 against affected areas. FIG. 6(A) shows a press member having a pointed pressing portion 4-3, FIG. 6(B) shows a press member having a substantially extended rounded pressing portion 4-4, and FIG. 6(C) shows a press portion having a recessed pressing portion 4-4. All these modifications are selectively used for the symptom of affected areas.

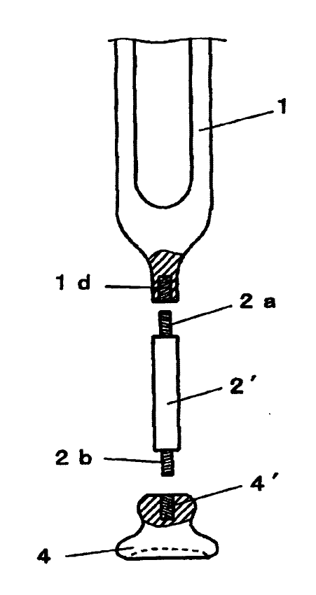

It is also acceptable to have a still further embodiment as shown in FIG. 7, in which the vibrating element 1, the transmission rod 2′ and the press member 4 are separately prepared with said transmission rod 2′ having opposite ends thereof formed with screws 2a and 2b such that the screw 2a is adapted to be detachably screwed into a female screw 1d formed in the base portion of the vibrating element 1 while the male screw 2b is adapted to be detachably screwed into a female screw 4′ formed in the press portion 4′.

As discussed above, the present invention provides a tuning fork type therapeutic utensil inexpensive, easy to handle and providing remarkable curing effects not only for the surfaces of the body but also deep and extensively into the body as far as into the osseous tissues.

1. A tuning fork type therapeutic utensil comprising a U-shaped vibrating element; a transmission rod attached to said U-shaped vibrating element at a base thereof; and a press member attached to said transmission rod at a tip end.

2. A tuning fork type therapeutic utensil according to claim 1, wherein said transmission rod is formed with a grip portion.
